(19) United States
(12) Patent Application Publication
(10) Pub. No.: US 2014/0220220 A1
(43) Pub. Date: Aug. 7, 2014

(54) TIGER NUT FOODSTUFF AND SYSTEMS AND METHODS FOR PROCESSING TIGER NUT FOODSTUFFS

(71) Applicant: NUTSO, LLC, Darnestown, MD (US)

(72) Inventors: Ernest Quaye Arday, Accra (GH); Juison Ng, Kuala Lumpur (MY); Isaac BK Taylor, Accra (GH); Kofi O. Tagoe-Mocumbi, Darnestown, MD (US); Gerhard Winkler, Vienna (AT)

(73) Assignee: NUTSO, LLC, Darnestown, MD (US)

(21) Appl. No.: 13/759,150

(22) Filed: Feb. 5, 2013

(51) Int. Cl. A23L 2/38; A23L 2/54

(52) U.S. Cl. CPC A23L 2/38; A23L 2/54
USPC 426/590; 426/521; 426/471; 426/477

(57) ABSTRACT

Systems and methods for producing a tiger nut beverage are described. The systems and methods may include mixing a tiger nut extract in powder form with one or more additives; combining the mixed tiger nut extract in powder form and the one or more additives with water to create a tiger nut syrup; flash pasteurizing the tiger nut syrup; and mixing the tiger nut syrup with water to create a finished tiger nut beverage. A composition including tiger nut liquid subject to flash pasteurization is also described.

### FIELD OF THE INVENTION

The present invention relates to systems and methods for tiger nut foodstuffs and, more specifically, to systems and methods for processing tiger nut foodstuffs.

### BACKGROUND OF THE INVENTION

Cyperus esculentus, also known as chufa sedge, nut grass, yellow nut sedge, tiger nut sedge, or earth almond, is a species of sedge native to warm temperate to subtropical regions of the Northern Hemisphere. Cyperus esculentus is cultivated in several locations around the world for its edible tubers, called tiger nuts. Tiger nuts have a slightly sweet, nutty flavor. Tiger nuts are known by several other names, including chufa and atadwe.

Raw tiger nuts are hard and are typically soaked in water before eating to soften them and improve their texture. They are quite hard, and are generally soaked in water before they can be eaten. Soaking makes the raw tiger nuts significantly softer and gives them a more pleasant texture. Tiger nuts are known to have excellent nutritional qualities, such as a fat composition similar to olives and a high mineral content, especially phosphorus and potassium.

In addition to consumption of the edible tubers, tiger nuts may be made into various other foods, such as cakes, pudding, etc. A popular use of tiger nuts is in the creation of tiger nut liquid, called horchata in Spain. Tiger nut liquid can be used as a milk substitute for individuals that are lactose intolerant.

The typical process for production of tiger nut liquid involves soaking raw tiger nuts for approximately 8 hours. The soaked tiger nuts are then ground and the resultant mass is pressed to remove the liquid. The liquid is then mixed with sugar to produce the final product.

Raw tiger nut liquid has a very short shelf life, often 2 to 3 days depending on the condition of storage. The minimal shelf life is often exacerbated by the ambient conditions where the beverage is typically produced and consumed, where high temperatures and humidity reduce the shelf life of the product significantly. As a result, raw tiger nut liquid is often associated with significant microbial contamination, including bacteria and molds. The short shelf life of raw tiger nut liquid hinders widespread consumption of the beverage because it is very difficult to process, ship and store while the product is fresh.

As a result, tiger nut liquid is often processed to increase shelf life. Pasteurization may be used to eliminate or reduce microbial contamination. The high temperatures and times associated with pasteurization, however, destroy the above-mentioned significant nutritional benefits of tiger nuts. Many of the beneficial compounds found in raw tiger nuts and raw tiger nut liquid are destroyed during the pasteurization process.

Needs exist for improved systems and methods for processing tiger nut liquid that maintain the beneficial compounds in the raw tiger nut liquid while improving shelf life of the tiger nut liquid.

### SUMMARY OF THE INVENTION

Embodiments of the present invention solve many of the problems and/or overcome many of the drawbacks and disadvantages of the prior art by providing systems and methods for maintaining the beneficial compounds in raw tiger nut liquid while improving shelf life of the tiger nut liquid.

Embodiments of the present invention may include systems and methods for producing a tiger nut beverage. The systems and methods may include soaking tiger nuts; grinding the tiger nuts into a mass; pressing of the resultant mass to extract tiger nut liquid; mixing the tiger nut liquid with one or more additives to create a tiger nut beverage; and flash pasteurizing the tiger nut beverage.

Embodiments of the present invention may include a composition including tiger nut liquid subject to flash pasteurization.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### DETAILED DESCRIPTION OF THE PREFERRED EMBODIMENTS

A tiger nut foodstuff may include a tiger nut beverage created by processing of raw tiger nuts. Preferably, a tiger nut beverage may retain most, if not all, of the beneficial compounds found in the raw tiger nuts. Additionally, the tiger nut beverage preferably has a shelf life of more than one week, more preferably more than one month, more preferably more than one year, and most preferably more than two years.

The tiger nut beverage may be a composition comprising tiger nut liquid and one or more additives. Additives may includes, but are not limited to, water, juices, tea, milk, sweeteners, carbonation, caffeine, herbs, vitamins, minerals, proteins, colorants, viscosity modifiers, preservatives, etc. Additives can be in liquid or powder form. The volume and/or weight of additives may be added based on a desired quantity of produced beverage. Water may be added and/or removed based on the desired characteristics of the final product. Additional liquids, such as juices, tea, milk, etc. may be added. Milk may be cow milk, goat milk, sheep milk, soy milk, etc. Sweeteners may be natural, such as sugar, syrup, honey, etc., or may be artificial. Carbonation may be added at various levels depending on the desired end product. The carbonation process may involve maintaining a constant temperature of the tiger nut mixture at a specific value and combining it with pressurized carbon dioxide. Caffeine and/or other stimulants may be added to create an energy-type drink. Herbs may include guarana, cordyceps, moringa, bupleurum, etc. Herbs may be dried and ground finely into a powder before addition. Herbs may be added for potential health benefits, biologic activity, and/or taste. Vitamins and minerals may be added, such as vitamin C, vitamin B12, etc. Other vitamins and minerals may be added to tiger nut drink to create various versions of a tiger nut beverage. Natural tiger nut is rich in minerals such as phosphorous, potassium and vitamins E and C. Proteins may be added for biologic activity or to increase the amount of protein in the beverage. Other additives may be added to modify the characteristics of the beverage for purposes, such as, but not limited to, increased shelf life, improved aesthetics, improved mouth feel, etc.

The tiger nut beverage may be flash pasteurized for improved shelf life. Flash pasteurization, also called “High Temperature Short Time” processing (HTST), is a method of heat pasteurization typically used for perishable beverages. Compared to other pasteurization processes, flash pasteurization can be better at maintaining color and flavor. Furthermore, flash pasteurization can potentially isolate and eliminate most or all harmful bacteria in the tiger nut beverage while retaining most or all beneficial compounds. Flash pasteurization may be performed prior to filling containers with tiger nut beverages. The tiger nut liquid may move in a controlled, continuous flow while subject to temperatures of approximately 160° F. to approximately 165° F. The tiger nut beverage may be exposed to these temperatures for approximately 15 seconds to approximately 90 seconds, more preferably approximately 30 to 60 seconds, and most preferably approximately 45 seconds. Flash pasteurization may be performed with syrup before filling into cans. Tunnel pasteurization may be performed after filling in the final cans. Tunnel pasteurization may take approximately 30 to approximately 40 minutes. Preferably, flash pasteurization is used with sterile fill technology to eliminate risk of post-pasteurization contamination.

The resultant beverage may have a high level of nutritional benefit. The tiger nut beverage may have most or all of the original beneficial enzymes and compounds in raw tiger nuts that promote digestion and have other health benefits. Furthermore, the resultant beverage may have a high energy value per serving that may be comparable to popular high caffeine energy drinks.

Embodiments of the present invention may also include systems and methods for creating the tiger nut beverages described above. An exemplary process for production of tiger nut beverage may include providing tiger nut milk extract in powder form. Alternatively, tiger nut milk extract in powder form may be produced by spray-drying liquid tiger nut milk to obtain a tiger nut extract in powder form. This process may involve soaking tiger nuts in liquid, where the resulting liquid is spray-dried to powder. A preferred ratio may be approximately 10:1, i.e., approximately 10 kg liquid may yield approximately 1 kg powder. The tiger nut extract in powder form may be mixed with one or more additives. The mixed tiger nut extract in powder form and the one or more additives may be mixed with water, preferably warm water, to create a tiger nut syrup. Warm water may preferably be 30-100° C., more preferably 40-90° C., more preferably 50-80° C., and more preferably 60-70° C. The tiger nut syrup may be flash pasteurized as described herein. The pasteurized tiger nut syrup may be mixed with water to create a finished tiger nut beverage. The tiger nut syrup and the water may be mixed in a predetermined proportion. In certain embodiments, the predetermined proportion may be one part tiger nut syrup to three parts water or one part tiger nut syrup to two parts water. In other embodiments, the predetermined proportion may be on part tiger nut syrup to five parts water or more. In one embodiment, the predetermined proportion may be one part tiger nut syrup to four parts water. The finished tiger nut beverage may be carbonate, if desired.

Water may be treated prior to use with embodiments of the present invention. Water may be treated using a reverse osmosis system. In certain embodiments, a standard water treatment system may include one or more of a booster pump, pretreatment units (quartz sand filter, active carbon filter and micropore-filter), a high pressure pump, a reverse osmosis membrane, conductivity meter, a UV sterilizer, controls and/or other components. The reverse osmosis system may effectively remove residual suspended solids and organic matter from water as well as killing bacteria and viruses.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method for producing a tiger nut beverage, the method comprising:
mixing a tiger nut extract in powder form with one or more additives;
combining the mixed tiger nut extract in powder form and the one or more additives with water to create a tiger nut syrup;
flash pasteurizing the tiger nut syrup; and
mixing the tiger nut syrup with water to create a finished tiger nut beverage.

2. The method of claim 1, further comprising spray-drying liquid tiger nut milk to obtain the tiger nut extract in powder form.

3. The method of claim 1, wherein the one or more additives are one or more herbs.

4. The method of claim 3, wherein the one or more herbs are selected from the group consisting of guarana, cordyceps, moringa, bupleurum, and combinations thereof.

5. The method of claim 1, wherein the water is warm when combined with the mixed tiger nut extract in powder form and the one or more additives.

6. The method of claim 1, wherein the flash pasteurizing is done at approximately 160° F. to approximately 165° F.

7. The method of claim 1, wherein the flash pasteurizing is done for approximately 15 seconds to approximately 90 seconds.

8. The method of claim 7, wherein the flash pasteurizing is done for approximately 30 seconds to approximately 60 seconds.

9. The method of claim 8, wherein the flash pasteurizing is done for approximately 45 seconds.

10. The method of claim 1, further comprising carbonating the tiger nut beverage.

11. A composition comprising tiger nut syrup subject to flash pasteurization.

12. The composition of claim 11, wherein the composition is carbonated.

13. The composition of claim 11, wherein the tiger nut syrup is mixed with water.

14. The composition of claim 11, further comprising one or more herbs.

15. The composition of claim 14, wherein the one or more herbs are selected from the group consisting of guarana, cordyceps, moringa, bupleurum, and combinations thereof. Error! Unknown document property name.
